(19) United States
(12) Patent Application Publication
(10) Pub. No.: US 2022/0366908 A1
(43) Pub. Date: Nov. 17, 2022

(54) INFORMATION PROCESSING APPARATUS AND INFORMATION PROCESSING METHOD

(71) Applicant: SONY GROUP CORPORATION, TOKYO (JP)

(72) Inventor: NORIHIRO TAKAHASHI, TOKYO (JP)

(21) Appl. No.: 17/753,869

(22) PCT Filed: Sep. 24, 2020
(86) PCT No.: PCT/JP2020/035904

§ 371 Date: Mar. 16, 2022

(30) Foreign Application Priority Data
Sep. 26, 2019 (JP) 2019-175087

(51) Int. Cl. G10L 15/22; G10L 15/30

(52) U.S. Cl. CPC G10L 15/22; G10L 15/30

(57) ABSTRACT

To enable a user to perform satisfactory correction or addition of an utterance request with respect to a voice agent.

A request utterance for a predetermined task is received from a user by an utterance input unit. Request information is transmitted by a communication unit to another information processing apparatus to which the predetermined task is to be requested. The request information includes information regarding a delay time until processing based on the request information is to be started. For example, when the communication unit transmits the request information to the other information processing apparatus, request content is visualized or made audible and thereby presented to the user by a presentation control unit. Because the other information processing apparatus executes processing based on the request information after delaying on the basis of the delay time information, the user can correct or add an utterance request during the delay time.

### TECHNICAL FIELD

The present technique relates to an information processing apparatus and an information processing method, and, in particular, relates to, for example, an information processing apparatus which is suitable to application to a voice agent system.

### BACKGROUND ART

In the past, a voice agent system configured by a plurality of voice agents being connected by a home network has been considered. Here, a voice agent means a device which combines speech recognition technology and natural language processing and provides a user with some kind of function or service in response to speech emitted by the user. Each voice agent cooperates with various services or various devices that correspond to an intended user or a feature. For example, PTL 1 discloses a voice agent system including a plurality of voice agents (a vacuum cleaner, an air conditioner, a television, a smartphone, etc.) in a home network, in which, in conjunction with instructions or responses between each agent, speech indicating the instructions or responses is outputted in order to allow each agent to have a human touch.

### CITATION LIST

### Patent Literature

### [PTL 1]

Japanese Patent Laid-Open No. 2014-230061

### SUMMARY

### Technical Problem

In a voice agent system as described above, it is assumed that any one voice agent is a core agent which accepts a request utterance for a predetermined task from a user, and assigns the predetermined task to an appropriate voice agent.

With a user request in accordance with natural language, even if utterance content thereof is vague or has ambiguity, the system will estimate or supplement a user intent, but it is not inherently possible for this estimation to be completely correct. In a case where various services or various devices are cooperating in a complicated manner, background information for a user utterance space widens, and estimation and supplementing become more difficult. Accordingly, the core agent can misinterpret a user request.

In a case where a core agent misinterprets a user request in such a manner, the user will understand the necessity of correcting or adding to the user request only after another agent, for which a task request is made by the core agent, starts processing corresponding to the request. For the user, there is a desire to notice the misinterpretation of the utterance request and correct or add the utterance request before the other agent starts processing corresponding to the request.

An objective of the present technique is to enable a user to perform satisfactory correction or addition of an utterance request with respect to a voice agent.

### Solution to Problem

An overview of the present technique relates to an information processing apparatus including

an utterance input unit that accepts a request utterance for a predetermined task from a user; and

a communication unit that transmits request information to another information processing apparatus to which the predetermined task is to be requested,

in which the request information includes information regarding a delay time until processing based on the request information is to be started.

In the present technique, a request utterance for a predetermined task is received from a user by the utterance input unit. Request information is transmitted by the communication unit to another information processing apparatus to which the predetermined task is to be requested. For example, the request information may include text information for the request text. The request information includes information regarding a delay time until processing based on the request information is to be started.

For example, an information obtainment unit that sends information regarding the request utterance to a cloud server and obtains the request information from the cloud server may be further provided. In this case, for example, the information obtainment unit may further transmit sensor information for determining a status to the cloud server.

In such a manner, in the present technique, the request information to be transmitted to the other information processing apparatus to which the predetermined task is to be requested includes information regarding a delay time until processing based on the request information is to be started. Accordingly, because the other information processing apparatus executes processing based on the request information after delaying on the basis of the delay time information, the user can correct or add an utterance request during the delay time.

Note that, in the present technique, for example, a presentation control unit that, when the communication unit transmits the request information to the other information processing apparatus, performs control to present to the user by visualizing request content or making the request content audible may be further provided. As a result, on the basis of audio output or a screen display indicating the presented request content, the user can easily notice when there is an error in the utterance request or the utterance request has been misinterpreted.

In this case, for example, presentation of audio indicating the request content includes a TTS (Text-To-Speech) utterance based on text information for request text, and the delay time may be an amount of time that corresponds to the amount of time for the TTS utterance. In addition, in this case, for example, the presentation control unit may determine whether or not it is necessary to execute the predetermined task while presenting the request content to the user, and when the presentation control unit determines that it is necessary to execute the predetermined task while presenting the request content to the user, the presentation control unit may perform control to present the request content to the user by visualizing the request content or making the request content audible. As a result, it is possible to avoid wastefully visualizing a task or making a task audible.

### BRIEF DESCRIPTION OF DRAWINGS

FIG. 1 is a block diagram illustrating an example of a configuration of a voice agent system as a first embodiment.

FIG. 2 is a block diagram illustrating an example of a configuration of a cloud server.

FIG. 3 is a view illustrating an example of a task map.

FIG. 4 is a view for describing an example of operation in the cloud server.

FIG. 5 is a view illustrating an example of a configuration of a voice agent.

FIG. 6 is a view for describing an example of operation in the voice agent system.

FIG. 7 is a sequence diagram for the example of operation in FIG. 6.

FIG. 8 is an operation sequence diagram for a voice agent system as a comparative example.

FIG. 9 is a view for describing an example of operation in a case where a user performs a correction.

FIG. 10 is a sequence diagram for the example of operation in FIG. 9.

FIG. 11 is a view illustrating an example of a screen display for request content, for example.

FIG. 12 is a block diagram illustrating an example of a configuration of a voice agent system as a second embodiment.

FIG. 13 is a view for describing an example of operation in the voice agent system.

FIG. 14 is a view for describing an example of operation in the voice agent system.

FIG. 15 is a flow chart illustrating an example of processing for selecting an execution policy in a third embodiment.

FIG. 16 is a view illustrating an example of tasks for which it is assumed that confirmation before execution is necessary.

FIG. 17 is a view for describing an example of operation for task execution in a case where a task is to confirm with a user before execution.

FIG. 18 is a sequence diagram for the example of operation in FIG. 17.

FIG. 19 is a view for describing an example of operation for task execution in a case where a task is to be immediately executed.

FIG. 20 is a sequence diagram for the example of operation in FIG. 19.

FIG. 21 is a view for describing an example of operation for task execution in a case where a task is to be immediately executed.

FIG. 22 is a sequence diagram for the example of operation in FIG. 21.

FIG. 23 is a block diagram illustrating an example of a configuration of a voice agent system as a fourth embodiment.

FIG. 24 is a block diagram illustrating an example of a configuration of a voice agent system as a fifth embodiment.

FIG. 25 is a block diagram illustrating an example of a configuration of a voice agent system as a sixth embodiment.

### DESCRIPTION OF EMBODIMENTS

Modes for working the invention (hereinafter, referred to as “embodiments”) are described below. Note that the description is given in the following order.

1. First Embodiment

2. Second Embodiment

3. Third Embodiment

4. Fourth Embodiment

5. Fifth Embodiment

6. Sixth Embodiment

7. Modifications

### 1. First Embodiment

[Example of Configuration of Voice Agent System]

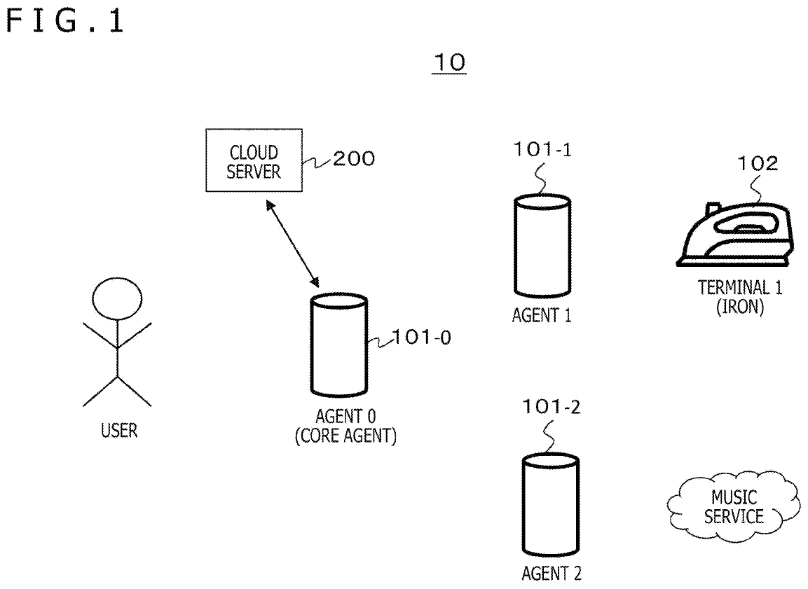

FIG. 1 illustrates an example of a configuration of a voice agent system 10 as a first embodiment. The voice agent system 10 has a configuration in which three voice agents 101-0, 101-1, and 101-2 are connected by a home network. The voice agents 101-0, 101-1, and 101-2 are smart speakers, for example, but another home appliance etc. may also serve as a voice agent.

The voice agent (agent 0) 101-0 accepts an utterance request for a predetermined task from a user, determines a voice agent to request the task to, and transmits request information to the determined voice agent. In other words, the voice agent 101-0 configures a core agent for assigning a predetermined task requested by a user to an appropriate voice agent.

The voice agent (agent 1) 101-1 can control operation by an iron (terminal 1) 102, and the voice agent (agent 2) 101-2 can access a cloud-based music service server.

The voice agent 101-0 sends request utterance speech information for a predetermined task to a cloud server 200, and request information for the predetermined task is obtained from the cloud server 200. Note that the voice agent 101-0 sends status information which includes a camera image, microphone audio, or other sensor information (constant sensing information) to the cloud server 200 together with the request utterance speech information which is information regarding the request utterance.

Note that, as request utterance speech information sent from the voice agent 101-0 to the cloud server 200, an audio signal for the request utterance or text data for the request utterance obtained by performing speech recognition processing on the audio signal can be considered. Description is given below assuming that the request utterance speech information is a request utterance audio signal.

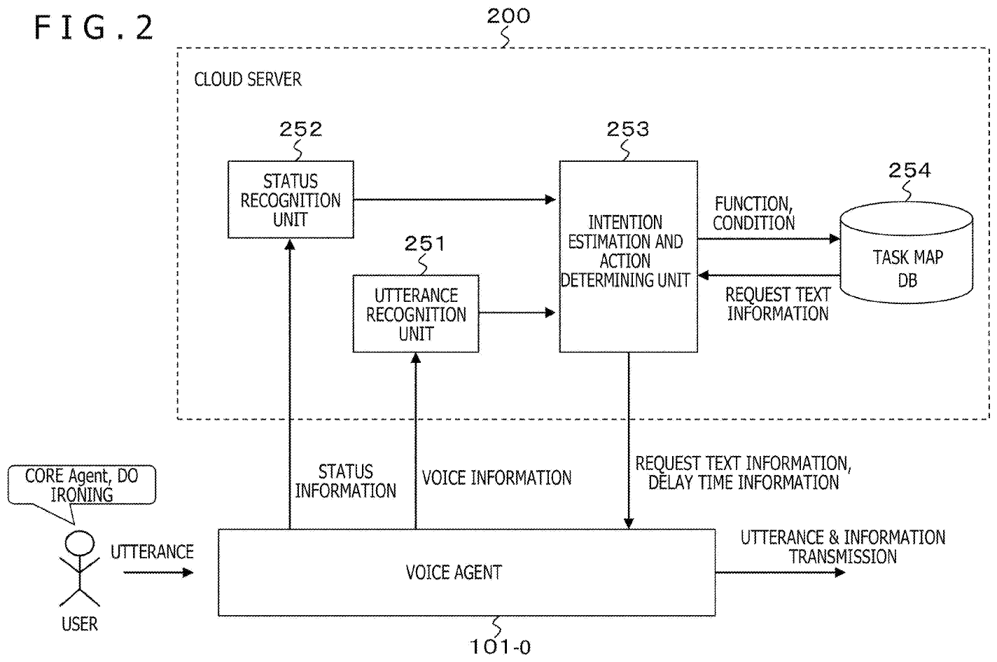

FIG. 2 illustrates an example of a configuration of the cloud server 200. The cloud server 200 has an utterance recognition unit 251, a status recognition unit 252, an intention determination and action planning unit 253, and a task map database 254.

The utterance recognition unit 251 obtains request utterance text data by performing speech recognition processing on the request utterance audio signal sent from the voice agent 101-0. The utterance recognition unit 251 also analyzes the request utterance text data to obtain information such as words, parts of speech, and dependencies, in other words, user utterance information.

The status recognition unit 252 obtains user status information on the basis of status information which includes a camera image or other sensor information sent from the voice agent 101-0. The user status information includes, for example, who the user is, what the user is doing, and what the state of the environment in which the user is in is.

The task map database 254 holds a task map in which each voice agent in a home network, functionality thereof, a condition, and request text therefor are registered. It is considered that the task map is generated by an administrator of the cloud server 200 inputting each item or is generated by the cloud server 200 communicating with each voice agent to thereby obtain necessary items.

The intention determination and action planning unit 253 determines a function and condition on the basis of the user utterance information obtained by the utterance recognition unit 251 and the user status information obtained by the status recognition unit 252. The intention determination and action planning unit 253 sends information regarding the function and the condition to the task map database 254 and receives, from the task map database 254, request text information (text data for the request text, information regarding a request destination device, and information regarding the function) corresponding to the function and the condition.

In addition, the intention determination and action planning unit 253 sends, as request information, a result of adding delay time information to the request text information received from the task map database 254, to the voice agent 101-0. This delay time is an amount of time that a request destination device which has received a request should wait until starting processing. The intention determination and action planning unit 253 determines the delay time (Delay) as in the following equation (1), for example. Here, “<Text length>” indicates the number of characters in the request text, and “<Text length>/10” indicates the utterance time for the request text. Note that “10” is an approximate value and is an example.

Delay=<Text length>/10+1 (sec) (1)

The voice agent 101-0 having received the request text information and the delay time information performs a TTS utterance on the basis of the text data for the request text, and sends the request text information and the delay time information to the request destination device.

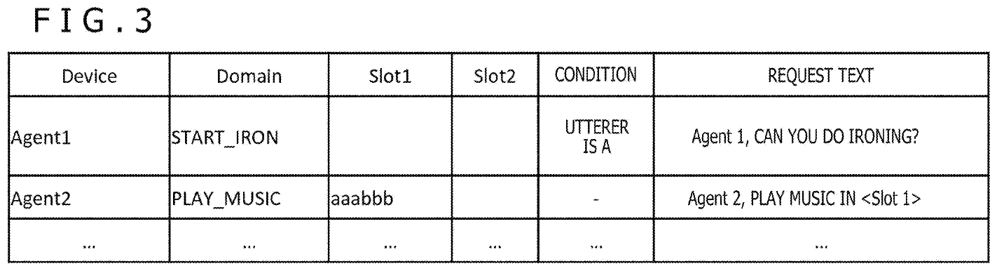

FIG. 3 illustrates an example of a task map. Here, “Device” indicates a request destination device, and agent names are disposed. “Domain” indicates a function. “Slot1,” “Slot2,” and “condition” indicate conditions. “Request text” indicates request text (text data).

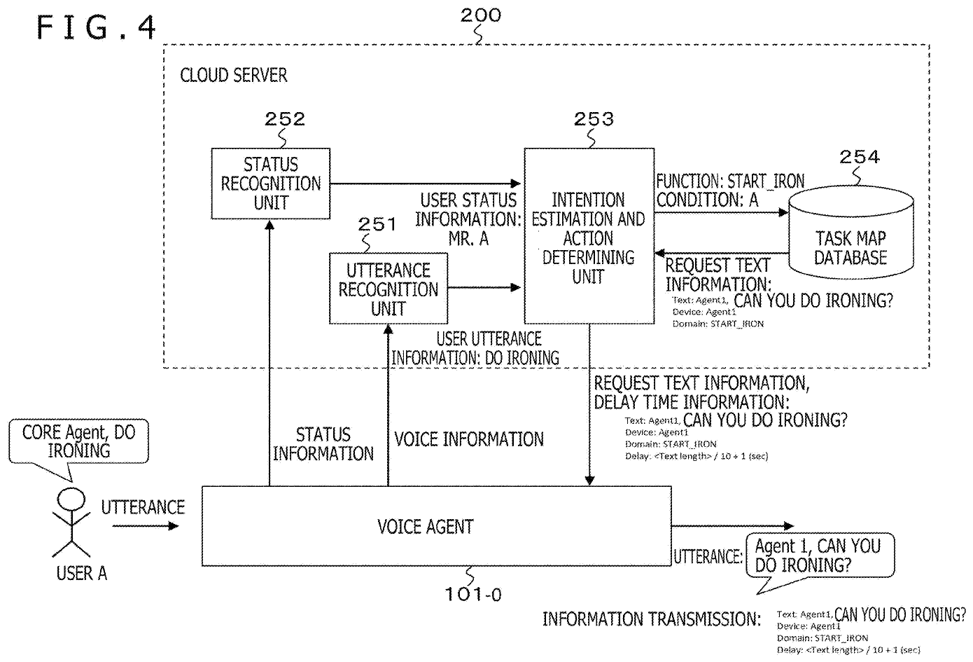

Here, as illustrated in FIG. 4, description is given regarding an example of operation in a case where a user A has uttered “core agent, do the ironing.” In this case, status information such as a camera image in which the user A appears is sent from the voice agent 101-0 to the cloud server 200 together with an audio signal for the utterance.

Voice information is inputted to the utterance recognition unit 251 in the cloud server 200, “do the ironing” is obtained as user utterance information, and is sent to the intention estimation and action planning unit 253. In addition, the status information such as a camera image in which the user A appears is inputted to the status recognition unit 252 in the cloud server 200, “Mr. A” is obtained as the user status information, and sent to the intention estimation and action planning unit 253.

The intention estimation and action determining unit 253 determines a function and condition on the basis of “do the ironing” as the user utterance information and “Mr. A” as the user status information. “START_IRON” is obtained as the function, “A” is obtained as a condition, and these are sent to the task map database 254.

The intention estimation and action planning unit 253 receives the following as request text information (text data for the request text, information regarding the request destination device, information regarding the function) from the task map database 254.

Text: Agent 1, can you do the ironing?

Device: Agent 1

Domain: START_IRON

The following is transmitted, as request text information and delay time information, from the intention estimation and action planning unit 253 to the voice agent 101-0.

Text: Agent 1, can you do the ironing?

Device: Agent 1

Domain: START_IRON

Delay: <Text length>/10+1 (sec)

The voice agent 101-0, which has received the request text information and the delay time information from the cloud server 200, transmits, as request information, the request text information and delay time information to the agent 1 (voice agent 101-1) which is a request destination device, and also makes a TTS utterance “Agent 1, can you do the ironing?” on the basis of the text data for the request text.

Note that, in the configuration of the cloud server 200 illustrated in FIG. 2, the intention estimation and action determining unit 253 is configured to determine a function and a condition from the user utterance information and the user status information, and supply these to the task map database 254 to thereby obtain request text information.

However, consideration can be given to, in the intention estimation and action determining unit 253, for example, a configuration in which a conversion DNN (Deep Neural Network) which has been trained in advance is used to obtain the request text information from the user utterance information and the user status information. In addition, in this case, consideration can be given for accumulating a combination for a case in which there has been no correction by a user as teaching data, and advancing training further in order to increase inference accuracy for the conversion DNN.

[Example of Configuration of Voice Agent]

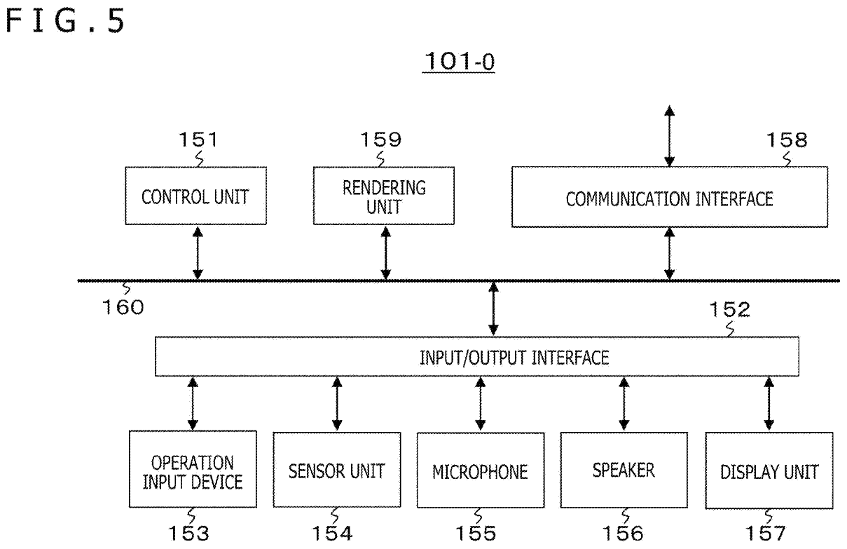

FIG. 5 is a view illustrating an example of a configuration of the voice agent 101-0. The voice agent 101-0 has a control unit 151, an input/output interface 152, an operation input device 153, a sensor unit 154, a microphone 155, a speaker 156, a display unit 157, a communication interface 158, and a rendering unit 159.

The control unit 151, the input/output interface 152, the communication interface 158, and the rendering unit 159 are connected to a bus 160.

The control unit 151 includes a CPU (Central Processing Unit, a ROM (Read Only Memory), a RAM (Random access Memory), etc., and controls operation of each unit in the voice agent 101-0. The input/output interface 152 is connected to the operation input device 153, the sensor unit 154, the microphone 155, the speaker 156, and the display unit 157.

The operation input device 153 configures an operation unit for an administrator of the voice agent 101-0 to input various operations. The sensor unit 154 includes an image sensor as a camera, or another sensor. For example, an image sensor is made to be able to capture an image of a user or an environment in the vicinity of the agent. The microphone 155 detects an utterance by a user to thereby obtain an audio signal. The speaker 156 outputs audio to a user. The display unit 157 performs a screen output for a user.

The communication interface 158 communicates with the cloud server 200 or another voice agent. The communication interface 158 transmits status information such as voice information obtained by sound collection by the microphone 155 or a camera image obtained by the sensor unit 154 to the cloud server 200, and receives request text information and delay time information from the cloud server 200. In addition, the communication interface 158 transmits the request text information, delay time information, etc. received from the cloud server 200 to another voice agent, and receives response information etc. from the other voice agent.

The rendering unit 159, for example, performs speech synthesis on the basis of text data, and supplies an audio signal therefor to the speaker 156. As a result, a TTS utterance is performed. In addition, in a case of performing an image display for text content, the rendering unit 159 generates an image on the basis of text data, and supplies an image signal therefor to the display unit 157.

Note that, although detailed explanation is omitted, the voice agents 101-1 and 101-2 are also configured similarly to the voice agent 101-0.

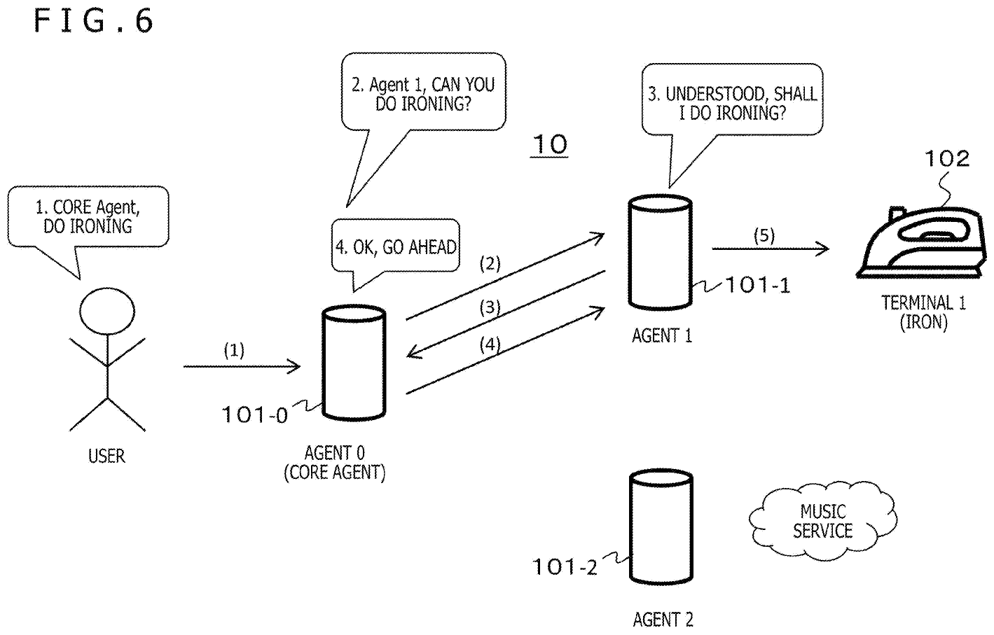

For the voice agent system 10 illustrated in FIG. 1, description is given with reference to FIG. 6 for an example of operation in a case where firstly a user has uttered “Core agent, do the ironing.” This utterance is sent to the voice agent 101-0 which is the core agent, as indicated by the arrow (1). Note that, in FIG. 6, numbers such as “1.” and “2.” inside utterances are numbers indicating an utterance order, are added for the convenience of the description, and are not uttered in the actual utterances.

Secondly, the voice agent 101-0 utters “Agent 1, can you do the ironing?” on the basis of text data for the request text received from the cloud server 200, as described above. As this time, the voice agent 101-0 makes a task request by sending the request text information and the delay time information in communication to the voice agent (agent 1) 101-1 which is a request destination agent, as indicated by the arrow (2).

In such a manner, the voice agent 101-0 performs a TTS utterance for the request text when making the task request to the voice agent (agent 1) 101-1. As a result, the instruction chain is made audible, and the user is able to easily notice, for example, an error in the instruction chain. This also applies to each subsequent stage.

In this case, the following is transmitted as the request text information and the delay time information. Here, “<Text length>/10” indicates the utterance time for the TTS utterance “Agent 1, can you do the ironing?” which is the request text.

Text: Agent 1, can you do the ironing?

Device: Agent 1

Domain: START_IRON

Delay: <Text length>/10+1 (sec)

Thirdly, the voice agent 101-1, after the delay time has elapsed, in other words, after waiting for a predetermined amount of time, which is one second here, to pass by after the utterance for “Agent 1, can you do the ironing?” by the voice agent 101-0 ends, utters “Understood, shall I do the ironing?” on the basis of text data for response text. At this time, the voice agent 101-1 responds by sending response text information and delay time information in communication to the voice agent 101-0, as indicated by the arrow (3).

In such a manner, a delay time is provided until the voice agent 101-1 starts processing, and a temporal gap in which a user can make a correction or an addition is ensured. This also applies to other subsequent stages.

In this case, the following is transmitted as the response text information and the delay time information. Here, “<Text length>/10” indicates the utterance time for the TTS utterance “Understood, shall I do the ironing?” which is the response text.

Text: Understood, shall I do the ironing?

Device: Agent 0

Domain: CONFIRM_IRON

Delay: <Text length>/10+1 (sec)

Fourthly, the voice agent 101-0, after the delay time has elapsed, in other words, after waiting for a predetermined amount of time, which is one second here, to pass by after the utterance for “Understood, shall I do the ironing?” by the voice agent 101-1 ends, utters “OK, go ahead” on the basis of text data for permission text. At this time, the voice agent 101-0 gives permission by sending permission text information and delay time information in communication to the voice agent 101-1, as indicated by the arrow (4).

In this case, the following is transmitted as the permission text information and the delay time information. Here, “<Text length>/10” indicates the utterance time for the TTS utterance “OK, go ahead” which is the permission text.

Text: OK, go ahead

Device: Agent 1

Domain: Ok IRON

Delay: <Text length>/10+1 (sec)

Fifthly, the voice agent 101-0, after the delay time has elapsed, in other words, after waiting for a predetermined amount of time, which is one second here, to pass by after the utterance for “OK, go ahead” by the voice agent 101-1 ends, orders, in communication, the iron 102 to execute “ironing” which is the task.

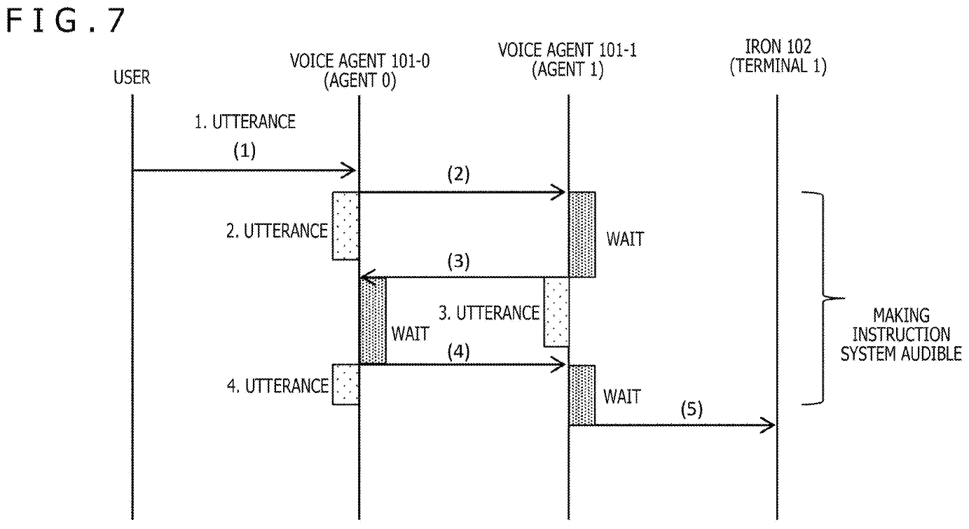

FIG. 7 illustrates a sequence diagram for the example of operation described above. The voice agent 101-1 which is the core agent, upon receiving (1) the request utterance (1. utterance) from the user, sends (2) the request text information and delay time information in communication to the voice agent 101-1 which is the request destination agent to thereby make a task request, and performs a TTS utterance for the request text (2. utterance). The voice agent 101-1, which has received the task request, waits without executing processing for the task request until a predetermined amount of time elapses after the request utterance by the voice agent 101-0 ends.

The voice agent 101-1, after wait time has elapsed, sends (3) the response text information and delay time information in communication to the voice agent 101-0 in order to respond, and also makes a TTS utterance for the response text (3. utterance). The voice agent 101-0, which has received the response, waits without executing processing for the response until a predetermined amount of time elapses after the response utterance by the voice agent 101-1 ends.

The voice agent 101-0, after wait time has elapsed, sends (4) the permission text information and delay time information in communication to the voice agent 101-1 in order to give permission, and also makes a TTS utterance for the permission text (4. utterance). The voice agent 101-1, which has received the permission, waits without executing processing for the permission until a predetermined amount of time elapses after the permission utterance by the voice agent 101-0 ends.

The voice agent 101-1 orders the iron 102 to execute the (5) task (ironing) after the wait time has elapsed.

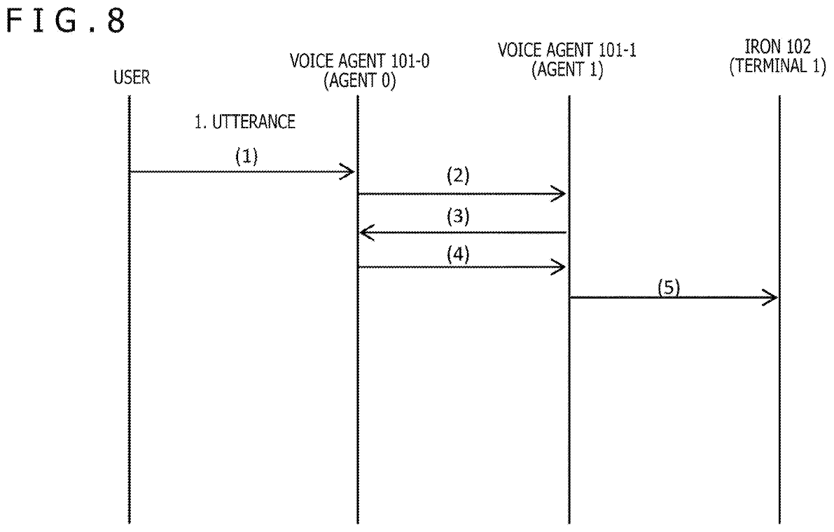

FIG. 8 illustrates, as a comparative example, a sequence diagram for a case in which delay times (wait times) for ensuring a temporal gap in which the user can make a correction or an addition are not provided, and TTS utterances for making the instruction chain audible are also not performed.

In this case, the voice agent 101-1 which is the core agent, upon receiving (1) the request utterance (1. utterance) from the user, sends (2) the request text information and delay time information in communication to the voice agent 101-1 which is the request destination agent to thereby make a task request. This voice agent 101-1, which has received the task request, immediately sends (3) response text information and delay time information to thereby make a response.

In addition, the voice agent 101-1, which has received the response, immediately sends (4) permission text information and delay time information to thereby give permission. The voice agent, which has received the permission, immediately orders the iron 102 to execute (5) the task (ironing).

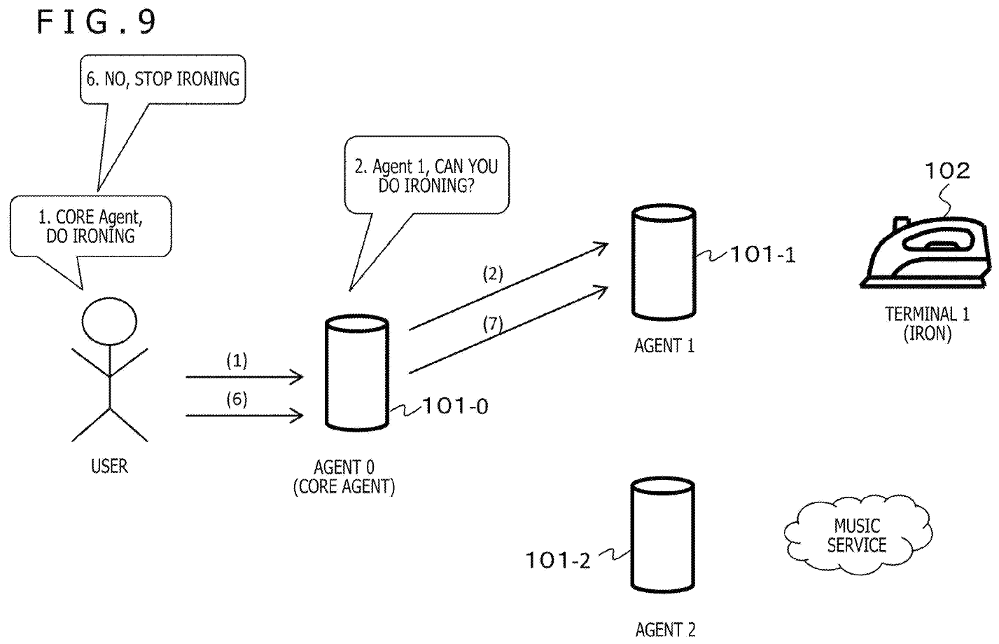

As described above, in the voice agent system 10 illustrated in FIG. 1, because delay time (wait time) is provided for a voice agent which has received a task request, response, or permission until the start of processing corresponding thereto, a user can effectively make a correction or an addition. An example of operation in a case in which a user makes a correction is described with reference to FIG. 9.

This example of operation is an example in a case in which firstly a user has uttered “Core agent, do the ironing.” This utterance is sent to the voice agent 101-0 which is the core agent, as indicated by the arrow (1).

Secondly, the voice agent 101-0 utters “Agent 1, can you do the ironing?” As this time, the voice agent 101-0 makes a task request by sending the request text information and the delay time information in communication to the voice agent (agent 1) 101-1 which is a request destination agent, as indicated by the arrow (2).

The voice agent 101-1, which has received the task request, is placed in a wait state without starting processing for this task request, until the delay time elapses. When the voice agent 101-1 is in the wait state in such a manner, the user notices that a wrong instruction has been made from the utterance “Agent 1, can you do the ironing?” by the voice agent 101-0, and thirdly, when the user makes the utterance “No, stop ironing,” this utterance is sent to the voice agent 101-0 as indicated by the arrow (6).

The voice agent 101-0, on the basis of the utterance “No, stop ironing” from the user, instructs cancellation of the task request in communication to the voice agent (agent 1) 101-1, as indicated by the arrow (7). As a result, the task request from the voice agent 101-0 to the voice agent 101-1 which goes against the user's intent is canceled. Note that, in this case, the voice agent 101-0 may perform the utterance “Agent 1, the ironing is canceled” to thereby inform the user that the ironing has been canceled.

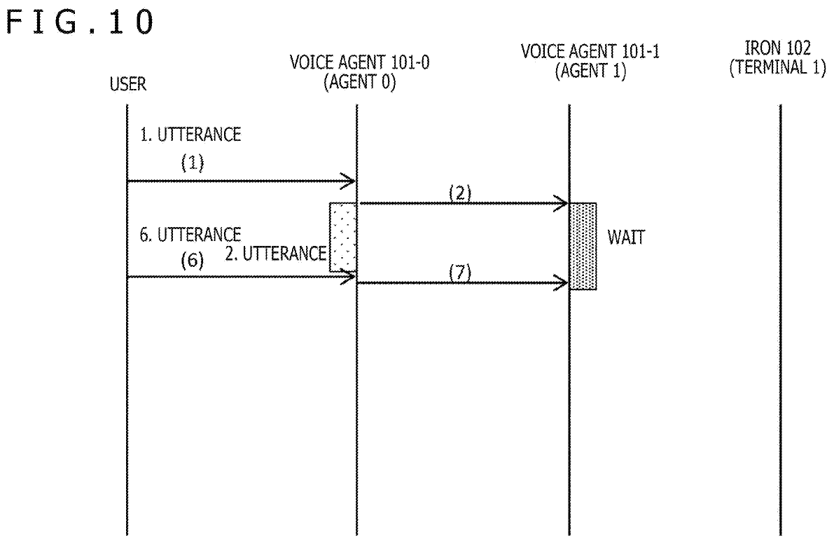

FIG. 10 illustrates a sequence diagram for the above-described example of operation. The voice agent 101-1 which is the core agent, upon receiving (1) the request utterance (1. utterance) from the user, sends (2) the request text information and delay time information in communication to the voice agent 101-1 which is the request destination agent to thereby make a task request, and performs a TTS utterance for the request text (2. utterance). The voice agent 101-1, which has received the task request, waits without executing processing for the task request until a predetermined amount of time elapses after the request utterance by the voice agent 101-1 ends.

When the voice agent 101-1 is in the wait state, the voice agent 101-1, upon receiving a (6) request cancellation utterance from the user (6. utterance), (7) instructs cancellation of the task request in communication to the voice agent 101-1.

As described above, in the voice agent system 10 illustrated in FIG. 1, request information sent by the voice agent 101-0, which is the core agent, in order to make a task request to a request destination agent includes delay time information. Accordingly, because the request destination agent executes processing based on the request information after delaying on the basis of the delay time information, the user can correct or add an utterance request during the delay time.

In addition, in the voice agent system 10 illustrated in FIG. 1, when the voice agent 101-0 which is the core agent makes a task request to a request destination agent, a TTS utterance for request text is performed, and it is assumed that request content is presented to the user. Accordingly, the instruction chain is made audible, and the user is able to easily notice, for example, an error in the instruction chain.

Note that, as described above, the voice agent 101-0 has a configuration for sending voice information and status information to the cloud server 200 and receiving request text information and delay time information from the cloud server 200, but causing the voice agent 101-0 to have the functionality of the cloud server 200 can be also considered.

In addition, description is given above for examples in which request text, response text, permission text, etc. are made audible by TTS utterances, but presenting to a user by subjecting each of these texts to a screen display, in other words, visualizing each of these texts can also be considered. Performing this screen display by the voice agent 101-0 which is core agent, for example, can be considered. This is possible because text data for each item of text is included in communications. The voice agent 101-0 generates a display signal on the basis of text data for each item of text, and performs a screen display on the display unit 157, for example.

In addition, this screen display can also be presented to the user by projecting the screen display onto a wall, for example, if the voice agent 101-0 includes a projection function. In addition, this screen display can also be performed on a television screen if the voice agent 101-0 is a television receiver instead of a smart speaker.

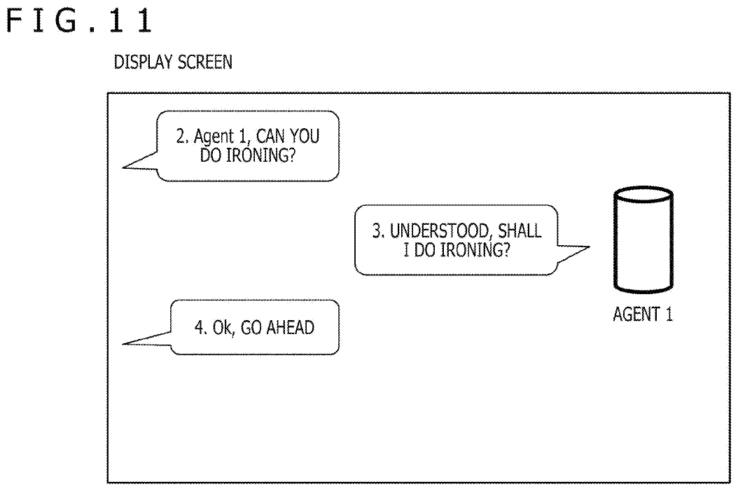

FIG. 11 illustrates an example of a screen display, and display is given in a chat format. Note that numbers in each text such as “2.” and “3.” are added to make an association with the utterance examples in FIG. 6, and are not displayed in practice. In this example, “Agent 1, can you do the ironing?” is request text from the voice agent 101-0 to the voice agent 101-1, “Understood, shall I do the ironing?” is response text from the voice agent 101-1 to the voice agent 101-0, and “OK, go ahead” is permission text from the voice agent 101-0 to the voice agent 101-1.

In the illustrated example, a series of texts exchanged between the core agent and the request destination agent are all displayed, but in practice the text for each stage is sequentially displayed. In this case, when the voice agent corresponding to each stage is in a wait state until starting processing, displaying a gist for this can also be considered.

Performing such a screen display is effective in a case of a noisy environment or in a case of being in a silent mode. In addition, by the core agent displaying everything, even in a case where the request destination agent is separated from the user, the state thereof can be conveyed to the user.

In addition, in the above description, TTS utterance for the request text and the permission text is performed by the voice agent 101-0 and TTS utterance for the response text is performed by the voice agent 101-1, but it is also possible for all of these to be performed by the voice agent 101-0. In this case, even in a case where the voice agent 101-1 is at a position separated from the user position, the user can satisfactorily hear the TTS utterance for the response text from the voice agent 101-0 which is nearby.

### 2. Second Embodiment

[Example of Configuration of Voice Agent System]

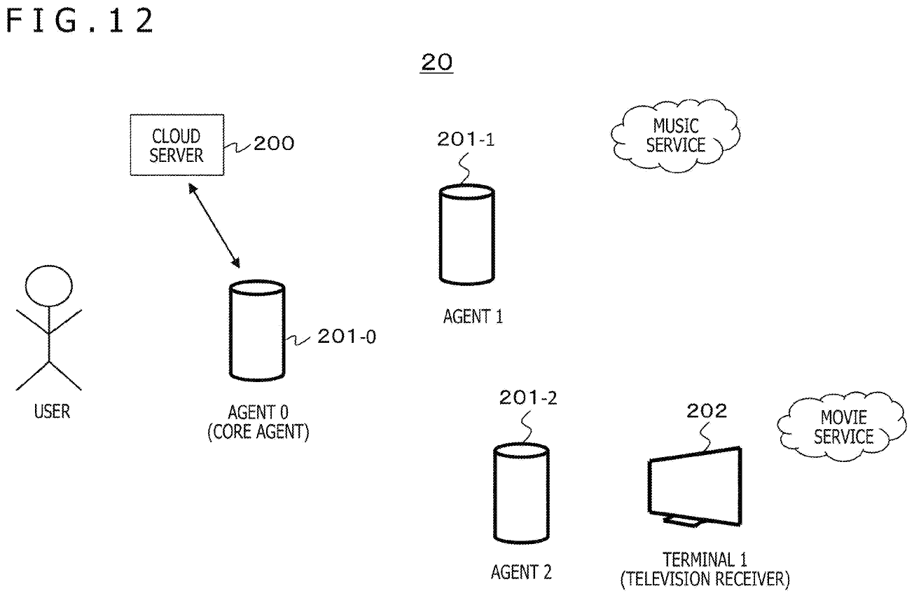

FIG. 12 illustrates an example of a configuration of a voice agent system 20 as a second embodiment. The voice agent system 20 has a configuration in which three voice agents 201-0, 201-1, and 201-2 are connected by a home network. The voice agents 201-0, 201-1, and 201-2 are smart speakers, for example, but another home appliance etc. may also serve as a voice agent. The voice agents 201-0, 201-1, and 201-2 are configured similarly to the voice agent 101-0 described above (refer to FIG. 5).

The voice agent (agent 0) 201-0 accepts an utterance request for a predetermined task from a user, determines a voice agent to request the task to, and transmits request information to the determined voice agent. In other words, the voice agent 201-0 configures a core agent for assigning a predetermined task requested by a user to an appropriate voice agent.

The voice agent (agent 1) 201-1 can access a cloud-based music service server. In addition, the voice agent (agent 2) 201-2 can control operation by a television receiver (terminal 1) 202. The television receiver 202 can access a cloud-based movie service server.

Similarly to the voice agent 101-0 described above, the voice agent 201-0 sends request utterance speech information for a predetermined task or status information such as a camera image to the cloud server 200, and obtains request information (request text information and delay time information) for this predetermined task from the cloud server 200. The voice agent 201-0 then sends the request text information and the delay time information to a request destination device.

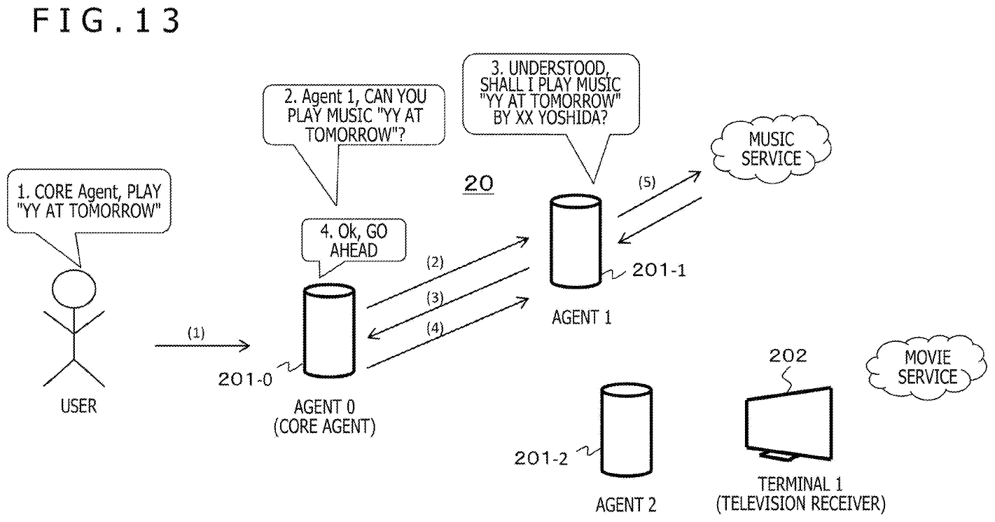

For the voice agent system 20 illustrated in FIG. 12, description is given with reference to FIG. 13 for an example of operation in a case where firstly a user has uttered “Core agent, play ‘YY at tomorrow’.” This utterance is sent to the voice agent 201-0 which is the core agent, as indicated by the arrow (1). Note that, in FIG. 13, numbers such as “1.” and “2.” inside utterances are numbers indicating an utterance order, are added for the convenience of the description, and are not uttered in the actual utterances.

Secondly, the voice agent 201-0, upon receiving the utterance from the user, sends the request text information and delay time information in communication to the voice agent 201-1 which is the request destination agent to thereby make a task request as indicated by the arrow (2), and performs a TTS utterance for request text “Agent 1, can you play the music ‘YY at tomorrow’?” The voice agent 201-1, which has received the task request, on the basis of the delay time information, waits without executing processing for the task request until a predetermined amount of time elapses after the request utterance by the voice agent 201-0 ends.

The voice agent 201-1, after wait time has elapsed, sends response text information and delay time information in communication to the voice agent 201-0 in order to respond as indicated by the arrow (3), and makes the TTS utterance for response text “Understood, shall I play the music ‘YY at tomorrow’ by XX Yoshida?” The voice agent 201-0, which has received the response, waits without executing processing for the response on the basis of the delay time information until a predetermined amount of time elapses after the response utterance by the voice agent 201-1 ends.

The voice agent 201-0, after wait time has elapsed, sends permission text information and delay time information in communication to the voice agent 201-1 as indicated by the arrow (4) in order to give permission, and also makes a TTS utterance for permission text “OK, go ahead.” The voice agent 201-1, which has received the permission, waits without executing processing for the permission until a predetermined amount of time elapses after the permission utterance by the voice agent 201-0 ends.

The voice agent 201-1, after wait time has elapsed, accesses the cloud-based music service server as indicated by the arrow (5), receives a streaming audio signal from the server, and performs music reproduction for “YY at tomorrow”.

In this case, because there is wait time at each stage, in a case where, despite an intention to reproduce a movie called “ZZ at tomorrow,” the user mistakenly has uttered “YY at tomorrow” as described above and wrong reproduction is about to start, the user can correct or add a task request in a duration until the voice agent 201-1 is finally accessing the cloud-based music service server.

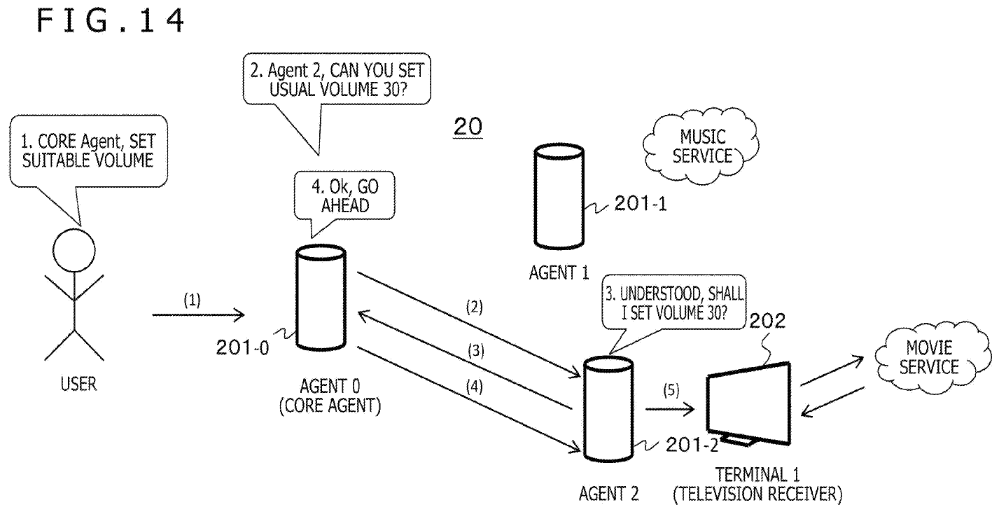

In addition, in the voice agent system 20 illustrated in FIG. 12, description is given with reference to FIG. 14 for an example of operation in a case where firstly a user has uttered “Core agent, set an appropriate volume.” Note that, at this time, it is assumed that the television receiver 202 has accessed the cloud-based movie service server, has received streamed image and audio signals from the server, and is performing image display and audio output, and the user is in a state of watching and listening to the image display and audio output.

This utterance is sent to the voice agent 201-0 which is the core agent, as indicated by the arrow (1). Note that, in FIG. 14, numbers such as “1.” and “2.” inside utterances are numbers indicating an utterance order, are added for the convenience of the description, and are not uttered in the actual utterances.

Secondly, the voice agent 201-0, upon receiving the utterance from the user, sends the request text information and delay time information in communication to the voice agent 201-2 which is the request destination agent to thereby make a task request as indicated by the arrow (2), and performs a TTS utterance for request text “Agent 2, can you set the usual volume 30?” The voice agent 201-2, which has received the task request, on the basis of the delay time information, waits without executing processing for the task request until a predetermined amount of time elapses after the request utterance by the voice agent 201-0 ends.

The voice agent 201-2, after wait time has elapsed, sends response text information and delay time information in communication to the voice agent 201-0 as indicated by the arrow (3) in order to respond, and also makes a TTS utterance for response text “Understood, shall I set volume 30?” The voice agent 201-0, which has received the response, waits without executing processing for the response on the basis of the delay time information until a predetermined amount of time elapses after the response utterance by the voice agent 201-2 ends.

The voice agent 201-0, after wait time has elapsed, sends permission text information and delay time information in communication to the voice agent 201-2 as indicated by the arrow (4) in order to give permission, and also makes a TTS utterance for permission text “OK, go ahead.” The voice agent 201-2, which has received the permission, waits without executing processing for the permission until a predetermined amount of time elapses after the permission utterance by the voice agent 201-0 ends.

The voice agent 201-2, after the wait time has elapsed, instructs the television receiver 202 to set the volume to 30 as indicated by the arrow (5).

In this case, because there is wait time at each stage, in a case where, despite intention to have a volume of approximately 15, a wrong volume adjustment due to lack of clarity is about to be performed as described above, the user can correct or add a task request in a duration until the voice agent 201-2 finally makes a wrong instruction for volume 30 to the television receiver 202.

### 3. Third Embodiment

In the embodiments described above, description is given for examples in which a task is executed with a delay together with visualizing the task or making the task audible.

However, it is considered that, in accordance with an execution task which the core agent requests of another agent, there are possibly “cases where there is a desire to execute the task with a delay together with visualizing the task or making the task audible,” “cases where there is a desire to execute the task immediately,” or “cases where there is a desire to confirm the task with the user before execution.”

In this case, it is possible to select an execution policy from the following (1), (2), and (3).

(1) Agent confirms the task with the user before execution

(2) Agent executes while visualizing the task or making the task audible

(3) Agent immediately executes the task

In a case of a task for which confirmation before execution by the user is assumed to be necessary, (1) is selected. In a case where task uniqueness is low (in a case where the vagueness or ambiguity of user input is greater than or equal to a threshold and there is a plurality of tasks that can be executed), (2) is selected. In a case where task uniqueness is high or in a case where it is determined that uniqueness is high after learning from habits (an execution history), (3) is selected. Note that the selection of an execution policy from (1) through (3) may be performed on the basis of correspondence between a command set in advance by a user and an execution policy. For example, the command “Call mother” is set in advance to correspond to the execution policy (3), etc.

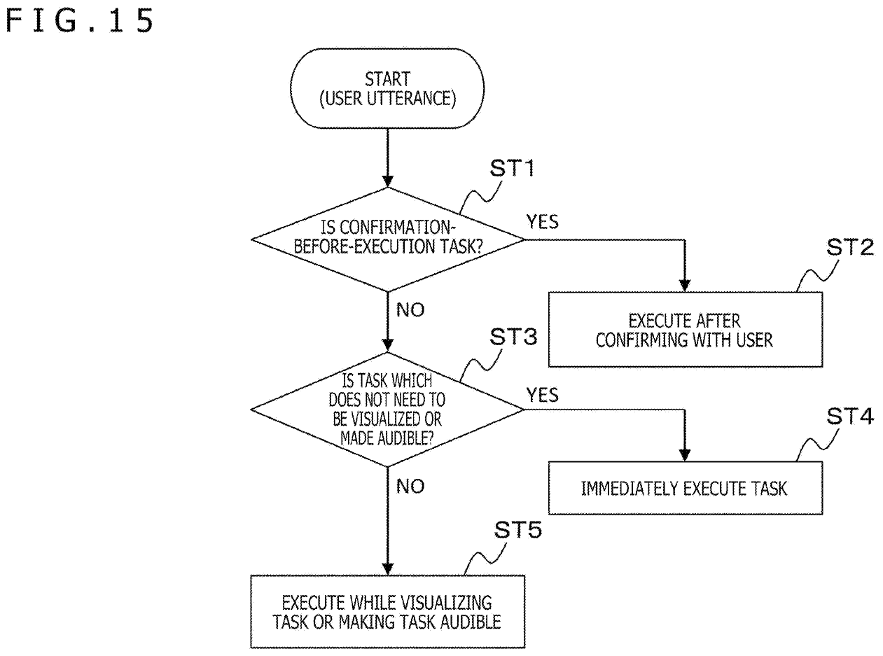

A flow chart in FIG. 15 illustrates an example of processing for selecting an execution policy. For example, this processing is performed by the core agent, and each agent operates such that a task is executed in accordance with the selected execution policy.

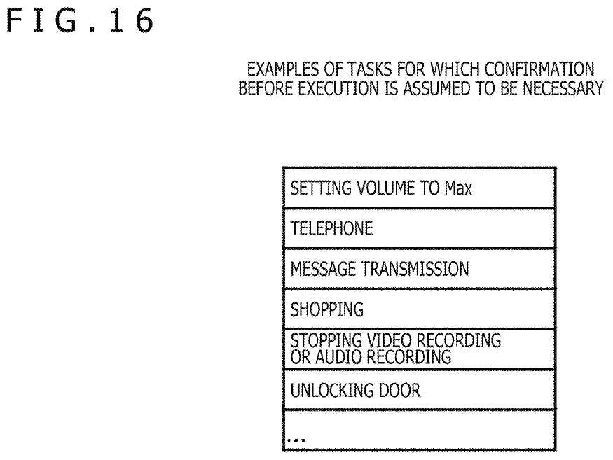

Processing starts by a request utterance from a user, and, in step ST1, a determination is made as to whether or not an execution task (task which is to be executed) is a confirmation-before-execution task. In a case where an execution task corresponds to a predefined task for which confirmation before execution is assumed to be necessary, for example, the execution task is determined to be a confirmation-before-execution task. FIG. 16 illustrate an example of tasks for which it is assumed that confirmation before execution is necessary.

In a case where it is determined that there is a confirmation-before-execution task, in step ST2, the execution policy for “(1) Agent confirms the task with the user before execution” described above is selected. In contrast, if it is determined that there is not a confirmation-before-execution task, in step ST3, a determination is made as to whether or not the execution task is a task which does not need to be visualized or made audible. This determination is performed on the basis of, for example, a usage history for the user, the presence or absence of another task that can be executed, the likelihood of speech recognition, etc.

Note that consideration can also be given to a configuration in which the likelihood of an execution task is determined through machine learning, and, if the likelihood is high, it is determined that a task does not need to be visualized or made audible. In this case, consideration can be given to accumulating, as teaching data, execution tasks for which there has been no correction in respect to request content and a context (such as a person, an environmental sound, a period of time, or a previous action) for the time of the request, performing modeling by a DNN etc., and utilizing the modeling in subsequent inferences.

In a case where it is determined that a task does not need to be visualized or made audible, in step ST4, the execution policy for “(3) Agent immediately executes the task” described above is selected. In contrast, in a case where it is determined that there is not a task which does not need to be visualized or made audible, in step ST5, the execution policy for “(2) Agent executes while visualizing the task or making the task audible” described above is selected.

[Task for which Agent Confirms Task with User Before Execution]

In a case where it is recognized that a request has been made to the core agent for a task for which confirmation is made with the user before execution, in other words, in a case where the execution policy “(1) Agent confirms the task with the user before execution” described above is selected, the core agent confirms the task with the user before execution.

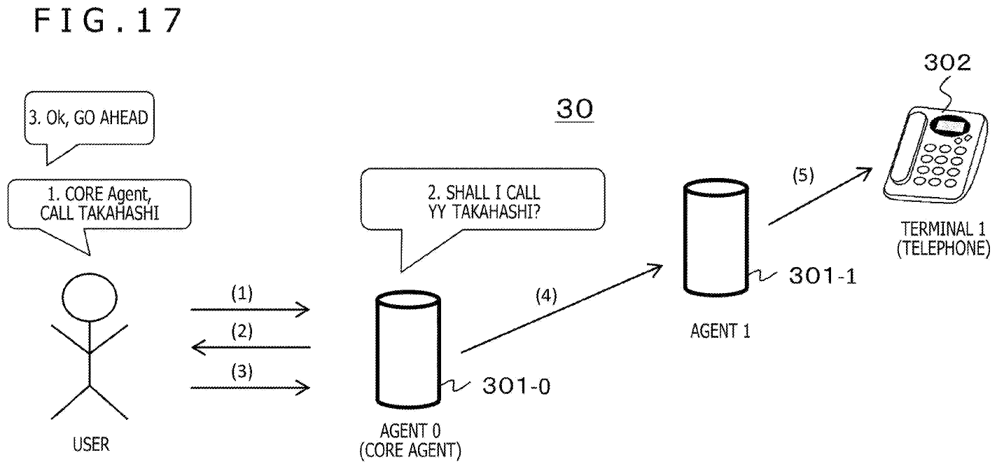

With reference to a voice agent system 30 illustrated in FIG. 17, description is given for an example of operation for task execution in a case where a task is to confirm with a user before execution. This voice agent system 30 has a configuration in which two voice agents 301-0 and 301-1 are connected by a home network. The voice agents 301-0 and 301-1 are smart speakers, for example, but another home appliance etc. may also serve as a voice agent.

The voice agent (agent 0) 301-0 accepts an utterance request for a predetermined task from a user, determines a voice agent to request the task to, and transmits request information to the determined voice agent. In other words, the voice agent 301-0 configures a core agent for assigning a predetermined task requested by a user to an appropriate voice agent. In addition, the voice agent (agent 1) 301-1 can control operation by a telephone (terminal 1) 302.

For the voice agent system 30 illustrated in FIG. 17, description is given for an example of operation in a case where firstly a user has made a request utterance “Core agent, call Takahashi.” This utterance is sent to the voice agent 301-0 which is the core agent, as indicated by the arrow (1). Note that, in FIG. 17, numbers “1.” and “2.” inside utterances are numbers indicating an utterance order, are added for the convenience of the description, and are not uttered in the actual utterances.

Secondly, the voice agent 301-0, upon receiving the request utterance from the user, recognizes that an execution task (a task which is to be executed) based on this request utterance is, for example, among predefined tasks for which confirmation before execution is assumed to be necessary and thus is a task to confirm with the user before execution. The voice agent 301-0 then makes the TTS utterance “Shall I call YY Takahashi?” in order to obtain confirmation from the user for the task which is to be executed, as indicated by the arrow (2).

Thirdly, when the task that the voice agent 301-0 is attempting to execute is correct, the user makes the confirmation utterance “OK, go ahead” as indicated by the arrow (3). Fourthly, the voice agent 301-0, upon receiving the confirmation utterance from the user, makes an execution request for the task in communication to the voice agent 301-1 which is the request destination agent, as indicated by the arrow (4). The voice agent 301-1, which has received the execution request for the task, instructs the telephone 302 to call “YY Takahashi,” as indicated by the arrow (5).

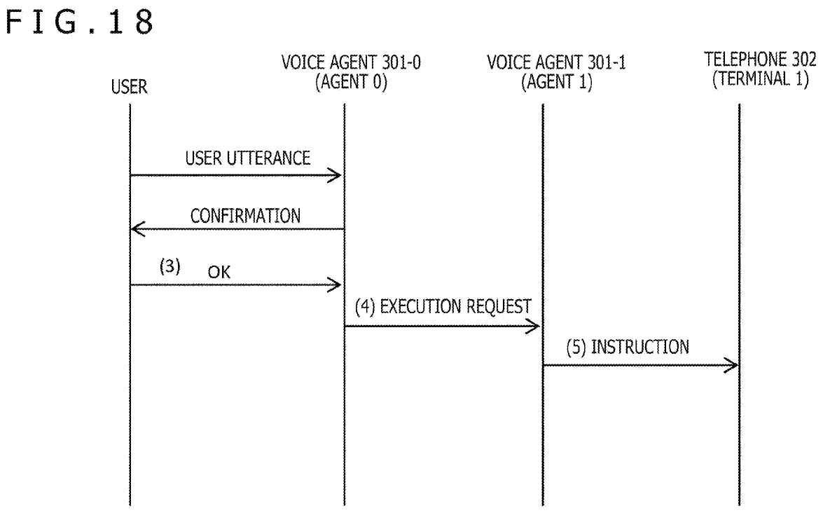

FIG. 18 illustrates a sequence diagram for the example of operation described above. The voice agent 301-0 which is the core agent, upon receiving (1) the request utterance from the user, (2) performs an utterance (TTS utterance) at the user in order to obtain confirmation for the task to be executed. In response, when the task to be executed is correct, the user (3) performs the confirmation utterance.

The voice agent 301-0, upon receiving the confirmation utterance from the user, (4) sends an execution request for the task in communication to the voice agent 301-1 which is the request destination agent. The voice agent 301-1, which has received the execution request for the task, (5) makes an instruction corresponding to the task for which execution is requested to the telephone 302.

[Task which Agent Immediately Executes]

The core agent, in a case of recognizing that a request for a task to be immediately executed has been made, in other words, in a case where the execution policy “(3) Agent immediately executes the task” described above has been selected, immediately sends an execution request for the task to a request destination agent.

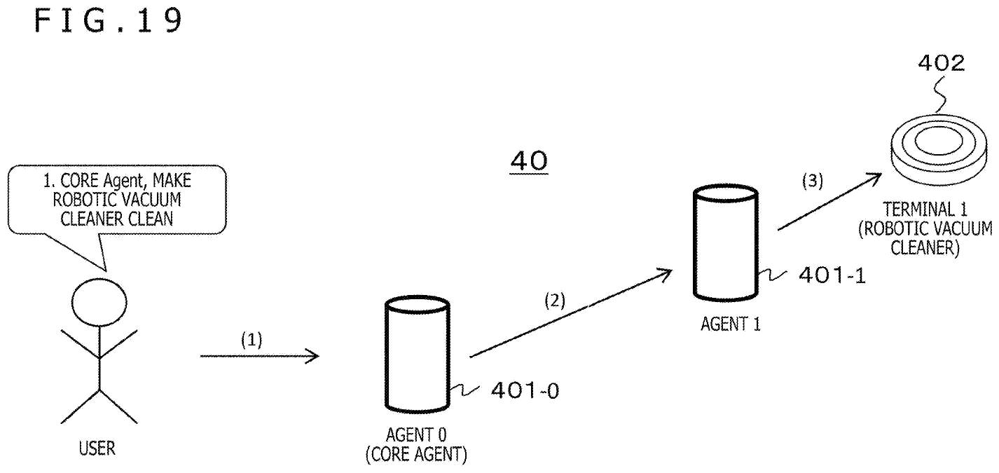

With reference to a voice agent system 40 illustrated in FIG. 19, description is given for an example of operation for task execution in a case where a task is to be immediately executed. This voice agent system 40 has a configuration in which two voice agents 401-0 and 401-1 are connected by a home network. The voice agents 401-0 and 401-1 are smart speakers, for example, but another home appliance etc. may also serve as a voice agent.

The voice agent (agent 0) 401-0 accepts an utterance request for a predetermined task from a user, determines a voice agent to request the task to, and transmits request information to the determined voice agent. In other words, the voice agent 401-0 configures a core agent for assigning a predetermined task requested by a user to an appropriate voice agent. In addition, the voice agent (agent 1) 401-1 can control operation by a robotic vacuum cleaner (terminal 1) 402.

For the voice agent system 30 illustrated in FIG. 19, description is given for an example of operation in a case where firstly a user has made the request utterance “Core agent, make the robotic vacuum cleaner clean.” This utterance is sent to the voice agent 401-0 which is the core agent, as indicated by the arrow (1). Note that, in FIG. 19, the number “1.” inside an utterance is a number indicating an utterance order, is added for the convenience of the description, and is not uttered in the actual utterance.

Secondly, the voice agent 401-0, upon receiving the request utterance from the user, recognizes that an execution task (task which is to be executed) based on this request utterance, in other words, “make the robotic vacuum cleaner clean,” is a task to be immediately executed on the basis of a determination that cleaning may be performed immediately due to a usage history for the user, the presence or absence of another task that can be executed, the likelihood of speech recognition, etc.

The voice agent 401-0 makes an execution request for the task in communication to the voice agent 401-1 which is the request destination agent, as indicated by the arrow (2). The voice agent 401-1, which has received the execution request for the task, then instructs the robotic vacuum cleaner 402 to clean as indicated by the arrow (3).

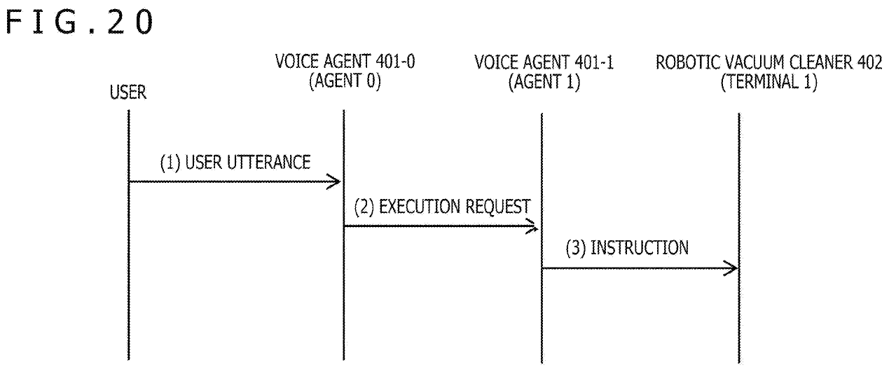

FIG. 20 illustrates a sequence diagram for the example of operation described above. The voice agent 401-0 which is the core agent, which has received (1) the request utterance from the user, determines that the execution task is a task to be executed immediately, and immediately sends (2) an execution request for the task in communication to the voice agent 401-1 which is the request destination agent. The voice agent 401-1, which has received the execution request for the task, (3) makes an instruction corresponding to the task for which execution is requested to the robotic vacuum cleaner 402.

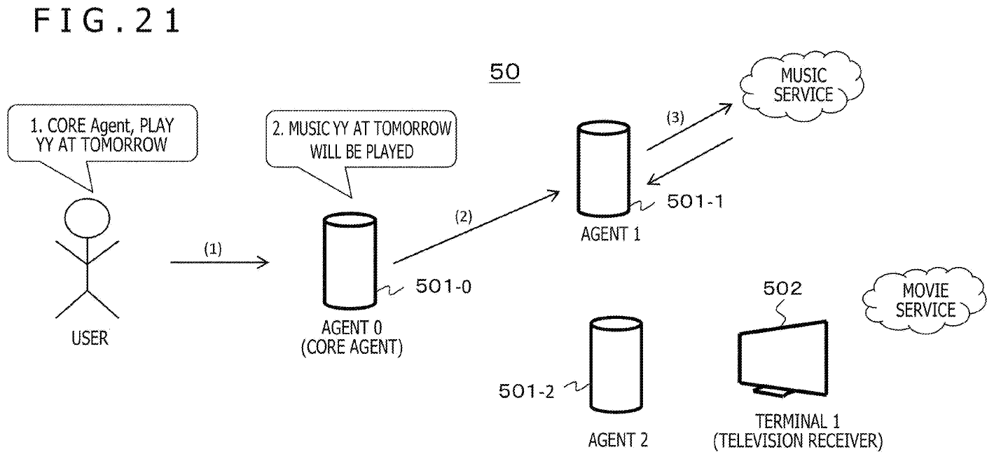

With reference to a voice agent system 50 illustrated in FIG. 21, description is given for another example of operation for task execution in a case where a task is to be immediately executed. This voice agent system 50 has a configuration in which three voice agents 501-0, 501-1, and 501-2 are connected by a home network. The voice agents 501-0, 501-1, and 501-2 are smart speakers, for example, but another home appliance etc. may also serve as a voice agent.

The voice agent (agent 0) 501-0 accepts an utterance request for a predetermined task from a user, determines a voice agent to request the task to, and transmits request information to the determined voice agent. In other words, the voice agent 501-0 configures a core agent for assigning a predetermined task requested by a user to an appropriate voice agent.

The voice agent (agent 1) 501-1 can access a cloud-based music service server. In addition, the voice agent (agent 2) 501-2 can control operation by a television receiver (terminal 1) 502. The television receiver 502 can access a cloud-based movie service server.

For the voice agent system 50 illustrated in FIG. 21, description is given for an example of operation in a case where firstly a user has made the request utterance “Core agent, play YY at tomorrow.” This utterance is sent to the voice agent 501-0 which is the core agent, as indicated by the arrow (1). Note that, in FIG. 21, numbers “1.” and “2.” inside utterances are numbers indicating an utterance order, are added for the convenience of the description, and are not uttered in the actual utterances.

Secondly, the voice agent 501-0, upon receiving the request utterance from the user, recognizes that an execution task (task which is to be executed) based on this request utterance, in other words, “play YY at tomorrow,” is a task to be immediately executed on the basis of a determination that this is music and not a movie due to a usage history for the user, the presence or absence of another task that can be executed, the likelihood of speech recognition, etc.

The voice agent 501-0 makes an execution request for the task in communication to the voice agent 501-1 which is the request destination agent, as indicated by the arrow (2). In addition, at this time, the voice agent 501-0 makes the TTS utterance “The music YY at tomorrow will be played.” As a result, the user can confirm that music reproduction is to be performed. Note that a case in which this TTS utterance is not present can also be considered.

The voice agent 501-1, which has received the execution request for the task, accesses the cloud-based music service server as indicated by the arrow (3), receives a streaming audio signal from the server, and performs music reproduction for “YY at tomorrow”.

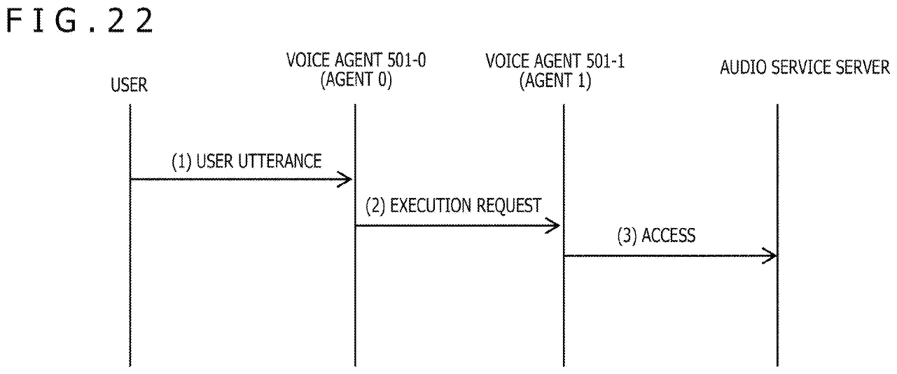

FIG. 22 illustrates a sequence diagram for the example of operation described above. The voice agent 501-0 which is the core agent, which has received (1) the request utterance from the user, determines that the execution task is a task to be executed immediately, and immediately sends (2) an execution request for the task in communication to the voice agent 501-1 which is the request destination agent. The voice agent 501-1, which has received the execution request for the task, (3) accesses the cloud-based music service server, and performs music reproduction.

[Task which Agent Executes while Visualizing Task or Making Task Audible]

The core agent, in a case of having confirmed that a task to be executed while visualizing the task or making the task audible has been requested, in other words, in a case where the execution policy “(2) Agent executes while visualizing the task or making task audible” described above has been selected, makes an execution request for the task while visualizing the request content or making the request content audible. An example of operation for task execution in this case is described above in the first and second embodiments described above, and thus is omitted here.

### 4. Fourth Embodiment

[Example of Configuration of Voice Agent System]

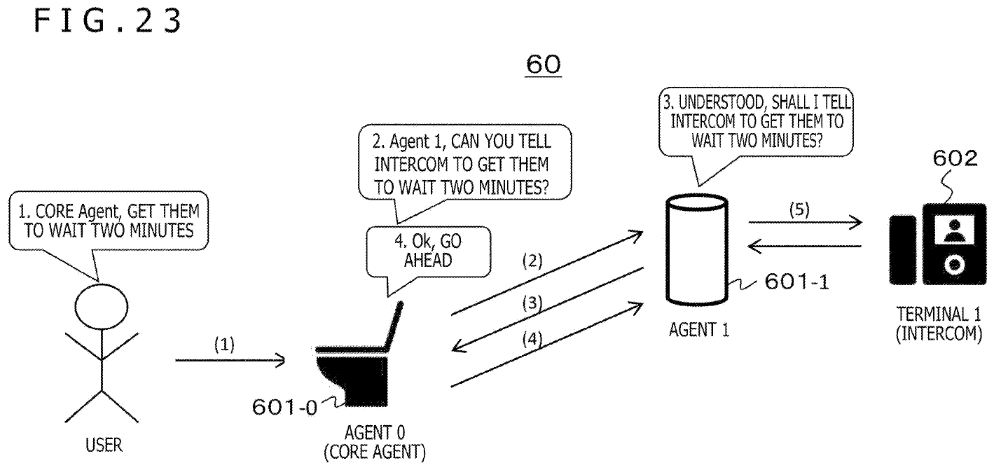

FIG. 23 illustrates an example of a configuration of a voice agent system 60 as a fourth embodiment. The voice agent system 60 has a configuration in which a toilet bowl 601-0 having a voice agent function and a voice agent (smart speaker) 601-1 are connected by a home network.

The toilet bowl (agent 0) 601-0 accepts an utterance request for a predetermined task from a user, determines a voice agent to request the task to, and transmits request information to the determined voice agent. In other words, the toilet bowl 601-0 configures a core agent for assigning a predetermined task requested by a user to an appropriate voice agent. In addition, the voice agent (agent 1) 601-1 can control operation by an intercom (terminal 1) 602.

Similarly to the voice agent 101-0 in the voice agent system 10 in FIG. 1, which is described above, the toilet bowl 601-0 sends request utterance speech information for a predetermined task or status information such as a camera image to the cloud server 200 (not illustrated in FIG. 23), and obtains request information (request text information and delay time information) for this predetermined task from the cloud server 200. The toilet bowl 601-0 then sends the request text information and the delay time information to a request destination device.

For the voice agent system 60 illustrated in FIG. 23, description is given for an example of operation in a case where firstly a user has made a request utterance “Core agent, get them to wait two minutes.” This utterance is sent to the toilet bowl 601-0 which is the core agent, as indicated by the arrow (1). Note that, in FIG. 23, numbers such as “1.” and “2.” inside utterances are numbers indicating an utterance order, are added for the convenience of the description, and are not uttered in the actual utterances.

Secondly, the toilet bowl 601-0, upon receiving the utterance from the user, sends the request text information and delay time information in communication to the voice agent 601-1 which is the request destination agent to thereby make a task request as indicated by the arrow (2), and performs a TTS utterance for request text “Agent 1, can you tell the intercom to get them to wait two minutes?” The voice agent 601-1, which has received the task request, on the basis of the delay time information, waits without executing processing for the task request until a predetermined amount of time elapses after the request utterance by the toilet bowl 601-0 ends.

The voice agent 601-1, after wait time has elapsed, sends response text information and delay time information in communication to the toilet bowl 601-0 as indicated by the arrow (3) in order to respond, and also makes a TTS utterance for response text “Understood, shall I tell the intercom to get them to wait two minutes?” The toilet bowl 601-0, which has received the response, waits without executing processing for the response on the basis of the delay time information until a predetermined amount of time elapses after the response utterance by the voice agent 601-1 ends.

The toilet bowl 601-0, after wait time has elapsed, sends permission text information and delay time information in communication to the voice agent 601-1 as indicated by the arrow (4) in order to give permission, and also makes a TTS utterance for permission text “OK, go ahead.” The voice agent 601-1, which has received the permission, waits without executing processing for the permission until a predetermined amount of time elapses after the permission utterance by the toilet bowl 601-0 ends.

The voice agent 601-1, after the wait time has elapsed, in communication to the intercom 602 as indicated by the arrow (5) makes an instruction to get the intercom 602 to get the visitor to wait two minutes. In this case, for example, the intercom 602 is made to perform a TTS utterance such as “Please wait two minutes” to the visitor.

In this case, when the user thinks again that “two minutes” is too long, because there is wait time at each stage, the user can correct or add the task request in a duration until the voice agent 601-1 finally supplies the instruction to the intercom 602.

### 5. Fifth Embodiment

[Example of Configuration of Voice Agent System]

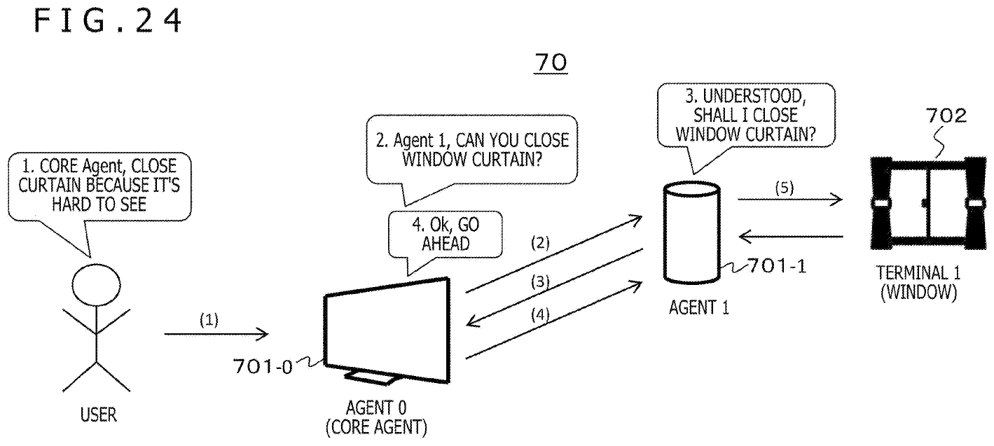

FIG. 24 illustrates an example of a configuration of a voice agent system 70 as a fifth embodiment. The voice agent system 70 has a configuration in which a television receiver 701-0 having a voice agent function and a voice agent (smart speaker) 701-1 are connected by a home network.

The television receiver (agent 0) 701-0 accepts an utterance request for a predetermined task from a user, determines a voice agent to request the task to, and transmits request information to the determined voice agent. In other words, the television receiver 701-0 configures a core agent for assigning a predetermined task requested by a user to an appropriate voice agent. In addition, the voice agent (agent 1) 701-1 can control operation by a window (terminal 1) 702.

Similarly to the voice agent 101-0 in the voice agent system 10 in FIG. 1, which is described above, the television receiver 701-0 sends request utterance speech information for a predetermined task or status information such as a camera image to the cloud server 200 (not illustrated in FIG. 24), and obtains request information (request text information and delay time information) for this predetermined task from the cloud server 200. The television receiver 701-0 then sends the request text information and the delay time information to a request destination device.

For the voice agent system 70 illustrated in FIG. 24, description is given for an example of operation in a case where firstly a user has made a request utterance “Core agent, close the curtain because it's hard to see.” This utterance is sent to the television receiver 701-0 which is core agent, as indicated by the arrow (1). Note that, in FIG. 24, numbers such as “1.” and “2.” inside utterances are numbers indicating an utterance order, are added for the convenience of the description, and are not uttered in the actual utterances.

Secondly, the television receiver 701-0, upon receiving the utterance from the user, sends the request text information and delay time information in communication to the voice agent 701-1 which is the request destination agent to thereby make a task request as indicated by the arrow (2), and performs a TTS utterance for request text “Agent 1, can you close the window curtain?” The voice agent 701-1, which has received the task request, on the basis of the delay time information, waits without executing processing for the task request until a predetermined amount of time elapses after the request utterance by the television receiver 701-0 ends.

The voice agent 701-1, after wait time has elapsed, sends response text information and delay time information in communication to the television receiver 701-0 as indicated by the arrow (3) in order to respond, and also makes a TTS utterance for response text “Understood, shall I close the window curtain?” The television receiver 701-0, which has received the response, waits without executing processing for the response on the basis of the delay time information until a predetermined amount of time elapses after the response utterance by the voice agent 701-1 ends.

The television receiver 701-0, after wait time has elapsed, sends permission text information and delay time information in communication to the voice agent 701-1 as indicated by the arrow (4) in order to give permission, and also makes a TTS utterance for permission text “OK, go ahead.” The voice agent 701-1, which has received the permission, waits without executing processing for the permission until a predetermined amount of time elapses after the permission utterance by the television receiver 701-0 ends.

The voice agent 701-1, after the wait time has elapsed, makes an instruction to close the curtain in communication to the window 702 as indicated by the arrow (5).

In this case, when the user wants to cancel closing of the window curtains, because there is wait time at each stage, the user can correct or add the task request in a duration until the voice agent 701-1 finally supplies the instruction to the window 702.

### 6. Sixth Embodiment

[Example of Configuration of Voice Agent System]

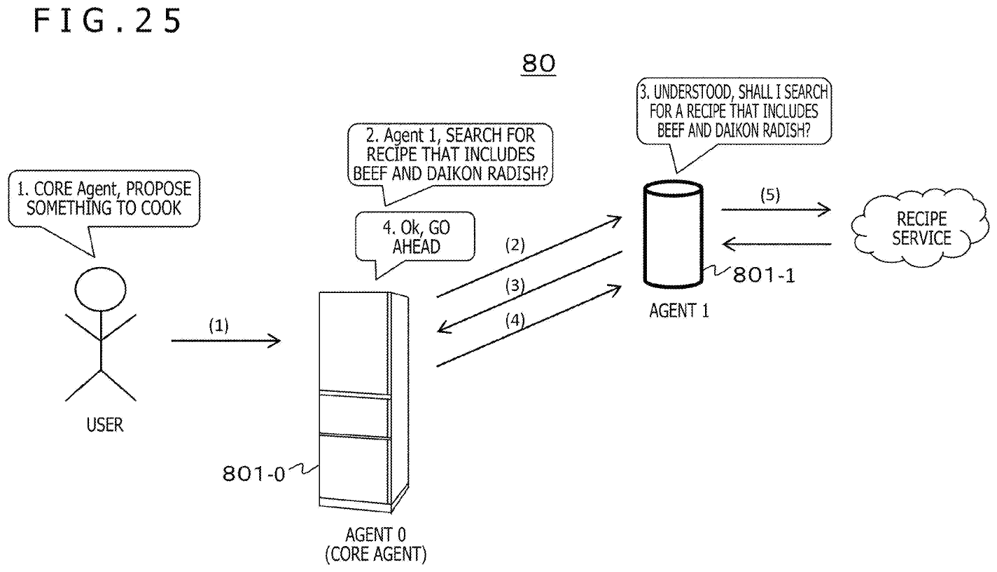

FIG. 25 illustrates an example of a configuration of a voice agent system 80 as a sixth embodiment. The voice agent system 80 has a configuration in which a refrigerator 801-0 having a voice agent function and a voice agent (smart speaker) 801-1 are connected by a home network.

The refrigerator (agent 0) 801-0 accepts an utterance request for a predetermined task from a user, determines a voice agent to request the task to, and transmits request information to the determined voice agent. In other words, the refrigerator 801-0 configures a core agent for assigning a predetermined task requested by a user to an appropriate voice agent. The voice agent (agent 1) 801-1 can access a cloud-based recipe service server.

Similarly to the voice agent 101-0 in the voice agent system 10 in FIG. 1, which is described above, the refrigerator 801-0 sends request utterance speech information for a predetermined task or status information such as a camera image to the cloud server 200 (not illustrated in FIG. 25), and obtains request information (request text information and delay time information) for this predetermined task from the cloud server 200. The refrigerator 801-0 then sends the request text information and the delay time information to a request destination device.

For the voice agent system 80 illustrated in FIG. 25, description is given for an example of operation in a case where firstly a user has made a request utterance “Core agent, propose something to cook.” This utterance is sent to the refrigerator 801-0 which is the core agent, as indicated by the arrow (1). Note that, in FIG. 25, numbers such as “1.” and “2.” inside utterances are numbers indicating an utterance order, are added for the convenience of the description, and are not uttered in the actual utterances.

Secondly, the refrigerator 801-0, upon receiving the utterance from the user, sends the request text information and delay time information in communication to the voice agent 801-1 which is the request destination agent to thereby make a task request as indicated by the arrow (2), and performs a TTS utterance for request text “Agent 1, search for a recipe that includes beef and daikon radish?” The voice agent 801-1, which has received the task request, on the basis of the delay time information, waits without executing processing for the task request until a predetermined amount of time elapses after the request utterance by the refrigerator 801-0 ends.

The voice agent 801-1, after wait time has elapsed, sends response text information and delay time information in communication to the refrigerator 801-0 as indicated by the arrow (3) in order to respond, and also makes a TTS utterance for response text “Understood, shall I search for a recipe that includes beef and daikon radish?” The refrigerator 801-0, which has received the response, waits without executing processing for the response on the basis of the delay time information until a predetermined amount of time elapses after the response utterance by the voice agent 801-1 ends.

The refrigerator 801-0, after wait time has elapsed, sends permission text information and delay time information in communication to the voice agent 801-1 as indicated by the arrow (4) in order to give permission, and also makes a TTS utterance for permission text “OK, go ahead.” The voice agent 801-1, which has received the permission, waits without executing processing for the permission until a predetermined amount of time elapses after the permission utterance by the refrigerator 801-0 ends.

The voice agent 801-1, after wait time has elapsed, accesses the cloud-based recipe service server as indicated by the arrow (5), searches for a corresponding recipe, and, although no illustration is given, sends a found recipe to the refrigerator 801-0, and a recipe for proposed cooking is displayed on a display unit in the refrigerator 801-0.

In this case, in a case where the user wishes to change to Japanese cuisine, for example, instead of simple cooking, because there is wait time at each stage, the user can correct or add the task request in a duration until the voice agent 801-1 finally accesses the recipe service server.

### 7. Modifications

Note that, in the embodiments described above, description is given by taking a toilet bowl, a television receiver, and a refrigerator as examples of home appliances which have a voice agent function, but it is possible to give examples of a washing machine, a rice cooker, a microwave oven, a personal computer, a tablet, a terminal apparatus, etc. as other home appliances.

In addition, description is given in detail regarding suitable embodiments according to the present disclosure with reference to the attached drawings, but examples in this description do not limit the technical scope of the present disclosure. It is apparent that a person having ordinary knowledge in the technical field of the present disclosure may conceive of various changes or modifications within the scope of the technical idea described in the claims, and it is naturally understood that they also belong to the technical scope of the present disclosure.

In addition, effects set forth in the present specification are purely descriptive or exemplary, and are not limiting. In other words, in addition to or in place of effects described above, the technology according to the present disclosure can achieve other effects that are obvious to a person skilled in the art from the description of the present specification.

In addition, the present technique can also have configurations such as the following.

(1) An information processing apparatus including:

an utterance input unit that accepts a request utterance for a predetermined task from a user; and

a communication unit that transmits request information to another information processing apparatus to which the predetermined task is to be requested,

in which the request information includes information regarding a delay time until processing based on the request information is to be started.

(2) The information processing apparatus according to the abovementioned (1), further including:

a presentation control unit that, when the communication unit transmits the request information to the other information processing apparatus, performs control to present request content to the user by visualizing the request content or making the request content audible.

(3) The information processing apparatus according to the abovementioned (2), in which

presentation of audio indicating the request content includes a TTS utterance based on text information for request text, and

the delay time is an amount of time that corresponds to an amount of time for the TTS utterance.

(4) The information processing apparatus according to the abovementioned (2) or (3), in which the presentation control unit determines whether or not it is necessary to execute the predetermined task while presenting the request content to the user, and when the presentation control unit determines that it is necessary to execute the predetermined task while presenting the request content to the user, the presentation control unit performs control to present audio or an image indicating the request content to the user.

(5) The information processing apparatus according to any one of the abovementioned (1) through (4), further including:

an information obtainment unit that sends information regarding the request utterance to a cloud server and obtains the request information from the cloud server.

(6) The information processing apparatus according to the abovementioned (5), in which

the information obtainment unit further transmits sensor information for determining a status to the cloud server.

(7) The information processing apparatus according to one of the abovementioned (1) through (6), in which the request information includes text information for request text.

(8) An information processing method including:

a procedure for accepting a request utterance for a predetermined task from a user; and

a procedure for transmitting request information to another information processing apparatus to which the predetermined task is to be requested,

in which the request information includes information regarding a delay time until processing based on the request information is to be started.

(9) An information processing apparatus including:

a communication unit that receives request information regarding a predetermined task from another information processing apparatus,

in which the request information includes information regarding a delay time until processing based on the request information is to be started, and

the information processing apparatus further includes a processing unit that executes processing based on the request information after delaying on the basis of the information regarding the delay time.

### REFERENCE SIGNS LIST

10: Voice agent system
101-0, 101-1, 101-2: Voice agent
102: Iron
151: Control unit
152: Input/output interface
153: Operation input device
154: Sensor unit
155: Microphone
156: Speaker
157: Display unit
158: Communication interface
159: Rendering unit
160: Bus
200: Cloud server
251: Utterance recognition unit
252: Status recognition unit
253: Intention estimation and action determining unit
254: Task map database
20: Voice agent system
201-0, 201-1, 201-2: Voice agent
202: Television receiver
30: Voice agent system
301-0, 301-1: Voice agent
302: Telephone
40: Voice agent system
401-0, 401-1: Voice agent
402: Robotic vacuum cleaner
50: Voice agent system
501-0, 501-1: Voice agent
502: Television receiver
60: Voice agent system
601-0: Toilet bowl
601-1: Voice agent
602: Intercom
70: Voice agent system
701-0: Television receiver
701-1: Voice agent
702: Window
80: Voice agent system
801-0: Refrigerator
801-1: Voice agent

1. An information processing apparatus comprising:
an utterance input unit that accepts a request utterance for a predetermined task from a user; and
a communication unit that transmits request information to another information processing apparatus to which the predetermined task is to be requested,
wherein the request information includes information regarding a delay time until processing based on the request information is to be started.

2. The information processing apparatus according to claim 1, further comprising:
a presentation control unit that, when the communication unit transmits the request information to the other information processing apparatus, performs control to present request content to the user by visualizing the request content or making the request content audible.

3. The information processing apparatus according to claim 2, wherein
presentation of audio indicating the request content includes a TTS utterance based on text information for request text, and
the delay time is an amount of time that corresponds to an amount of time for the TTS utterance.

4. The information processing apparatus according to claim 2, wherein
the presentation control unit determines whether or not it is necessary to execute the predetermined task while presenting the request content to the user, and when the presentation control unit determines that it is necessary to execute the predetermined task while presenting the request content to the user, the presentation control unit performs control to present the request content to the user by visualizing the request content or making the request content audible.

5. The information processing apparatus according to claim 1, further comprising:
an information obtainment unit that sends information regarding the request utterance to a cloud server and obtains the request information from the cloud server.

6. The information processing apparatus according to claim 5, wherein
the information obtainment unit further transmits sensor information for determining a status to the cloud server.

7. The information processing apparatus according to claim 1, wherein
the request information includes text information for request text.

8. An information processing method comprising:
a procedure for accepting a request utterance for a predetermined task from a user; and
a procedure for transmitting request information to another information processing apparatus to which the predetermined task is to be requested,
wherein the request information includes information regarding a delay time until processing based on the request information is to be started.

9. An information processing apparatus comprising:
a communication unit that receives request information regarding a predetermined task from another information processing apparatus,
wherein the request information includes information regarding a delay time until processing based on the request information is to be started, and
the information processing apparatus further includes a processing unit that executes processing based on the request information after delaying on a basis of the information regarding the delay time.
